(19) United States
(12) Patent Application Publication
(10) Pub. No.: US 2010/0148944 A1
(43) Pub. Date: Jun. 17, 2010

(54) HAPTIC FUNCTION CONTROL METHOD FOR PORTABLE TERMINALS

(75) Inventors: Po-Ra KIM, Seoul (KR); Eun-Hwa Lee, Suwon-si (KR); In Kim, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/640,694

(22) Filed: Dec. 17, 2009

(30) Foreign Application Priority Data
Dec. 17, 2008 (KR) 10-2008-0128818

(51) Int. Cl. H04B 3/36

(52) U.S. Cl. 340/407.1

(57) ABSTRACT

A haptic function control method for a portable terminal including a receipt-specific vibration motor that vibrates in a first frequency band and a haptic-specific vibration motor that vibrates in a second frequency band. At least one of the receipt-specific vibration motor and the haptic-specific vibration motor is driven based on a drive sampling frequency signal. The drive sampling frequency signal that vibrates the receipt-specific vibration motor and the haptic-specific vibration motor is determined from the first frequency band and the second frequency band.

### PRIORITY

This application claims priority under 35 U.S.C. §119(a) to an application filed in the Korean Industrial Property Office on Dec. 17, 2008 and assigned Serial No. 10-2008-0128818, the content of which is incorporated herein by reference.

### BACKGROUND OF THE INVENTION

1. Field of the Invention

The present invention relates generally to a portable terminal, and more particularly to a haptic function control method of a portable terminal that can provide a haptic feedback function.

2. Description of the Related Art

Haptic feedback, often referred to as simply “haptics”, is the use of the sense of touch in a user interface design to provide information to an end user. When referring to mobile phones and similar devices, this generally means the use of vibrations from the device's vibration alarm to denote that a touchscreen button has been pressed. In this particular example, the phone would vibrate slightly in response to user activation of an on-screen control, making up for the lack of a normal tactile response that the user would experience when pressing a physical button.

A vibration motor, which is normally used to indicate a received text message or an incoming call in a portable terminal, may also be used to provide haptic feedback in the portable terminal. The vibration motor is commonly a coin type and a cylinder, or bar type. However, these coin type or a bar type motors were designed simply to provide vibration functions suitable for a receipt notification function.

As a result, the coin type or a bar type motors are often limited in realizing the haptic feedback function, mostly because the response time of these vibration motors is longer. That is, when using the coin type or a bar type motors, it is often difficult for a user to tactually recognize key inputs on a touch screen, when for example, a continuous key input is performed at a fast pace, because the coin type or bar type vibration motor continues to vibrate by inertia, even after the user has recognized a first key input and is attempting to enter a second key input. This continued vibration, even if for a very short interval, makes it difficult for the user to tactually recognize the second key input.

A linear motor having lower power consumption and high reliability has been proposed as a new type of vibration motor with an improved, short response time. However, the vibration pattern is relatively simple and thus there is a limit on available haptic functions that can be provided from terminal enabled with the linear motor alone. More specifically, because the prior art linear motor simply adjusts only amplitude, it is difficult to deliver distinguishable tactic information for various manipulations through a touch screen, such as drag, signal value input, and a selected command execution.

### SUMMARY OF THE INVENTION

Accordingly, the present invention is has been designed to solve at least the aforementioned problems in the prior art and provide at least the advantages described below. An aspect of the present invention provides a control method for providing an improved haptic function presenting an altered vibration pattern according to various user manipulation modes, such as dragging or a continual touch time, for manipulation of a touch screen.

In accordance with an aspect of the present invention, there is provided a haptic function control method for a portable terminal. The method includes setting a receipt-specific vibration motor that provides a receipt-specific vibration motor vibrating in a first frequency band, setting a haptic-specific vibration motor that provides a haptic-specific vibration motor vibrating in a second frequency band, setting a drive sampling frequency signal that vibrates the receipt-specific vibration motor and the haptic-specific vibration motor, and driving at least one of the receipt-specific vibration motor and the haptic-specific vibration motor by applying the drive sampling frequency signal set in the sampling step.

### BRIEF DESCRIPTION OF THE DRAWINGS

The above and other aspects, features, and advantages of the present invention will be more apparent from the following detailed description taken in conjunction with the accompanying drawings, in which:

FIG. 1 indicates frequency characteristics of a receipt-specific vibration motor used in a haptic function control method of a portable terminal according to an embodiment of the present invention;

FIG. 2 indicates frequency characteristics of a haptic-specific vibration motor used in a haptic function control method of a portable terminal according to an embodiment of the present invention;

FIGS. 3A and 3B illustrate drive sampling frequency signals used in the receipt-specific and haptic-specific vibrator motors having frequency characteristics as illustrated in FIG. 1 and FIG. 2, respectively;

FIG. 4 illustrates an operation of a receipt-specific vibration motor having frequency characteristics as illustrated in FIG. 1, according to an embodiment of the present invention;

FIG. 5 illustrates an enlargement of S portion illustrated in FIG. 4;

FIG. 6 illustrates an operation of a haptic-specific vibration motor having frequency characteristics as illustrated in FIG. 2, according to an embodiment of the present invention;

FIG. 7 illustrates vibration characteristics according to a haptic-specific function control method of a portable terminal according to an embodiment of the present invention; and

FIG. 8 is a flow chart illustrating a haptic operation of a portable terminal implementing a haptic-specific function control method according to an embodiment to the present invention.

### DETAILED DESCRIPTION OF EMBODIMENTS OF THE INVENTION

Hereinafter, certain embodiments of the present invention will be described in detail with reference to the accompanying drawings. Further, in the following description of the present invention, a detailed description of known functions and components incorporated herein will be omitted when it may make the subject matter of the present invention rather unclear.

As described above, the haptic function control method of a portable terminal is mainly related to selectively operating at least one of a receipt-specific vibration motor and a haptic-specific vibration motor mounted for providing a haptic function. The receipt-specific vibration motor used in a general signal reception, i.e., a notification function, such as for an incoming voice call or message arrival.

When the receipt-specific vibration motor and the haptic-specific vibration motor are simultaneously driven, a unitary vibration pattern is repeatedly driven. Herein, the length of the unitary vibration pattern is maintained as a common multiple of vibration frequencies of two vibration motors, thereby preventing the occurrence of high frequency components resulting from the discontinuity of a waveform in the junction of the unitary vibration pattern. Accordingly, when operating the receipt-specific vibration motor and the haptic-specific vibration motor simultaneously or in turn, in accordance with an embodiment of the present invention, two vibration motors are synchronized in order to prevent different waveforms of the two vibration motors from conflicting with each other at a joining point.

According to an embodiment of the present invention, the haptic function control method of a portable terminal includes providing (installing) a receipt-specific vibration motor and a haptic-specific vibration motor, setting a drive sampling frequency signal for driving the two vibration motors, and driving at least one of the haptic-specific vibration motor and the haptic-specific vibration motor by applying the drive sampling frequency signal.

It is noted that providing the receipt-specific and haptic-specific vibration motors and setting a drive sampling frequency signal is substantially performed in the design and manufacturing stage of a terminal, and driving at least one of the receipt-specific and haptic-specific vibration motors is performed during use of the manufactured portable terminal. That is, during the design and manufacturing stage of a terminal, real vibration frequencies of the receipt-specific and haptic-specific vibration motors are determined. A drive sampling frequency signal value is then determined according to the determined vibration frequency of the receipt-specific and haptic-specific vibration motors. Accordingly, when a user manipulates the terminal, at least one of the receipt-specific and haptic-specific vibration motors is actuated according to the drive sampling frequency signal value.

Herein, “vibration frequency” means a frequency at which such two vibration motors substantially vibrate on a terminal, and it does not necessarily mean a resonance frequency of each vibration motor. However, for the receipt-specific vibration motor, when vibrating not at a resonance frequency but at other frequencies, the vibration power, i.e., its amplitude, decreases drastically, whereas the haptic-specific vibration motor can provide enough vibration power needed to realize the haptic function in a wider frequency range than the receipt-specific vibration motor, even though it does not vibrate at a resonance frequency.

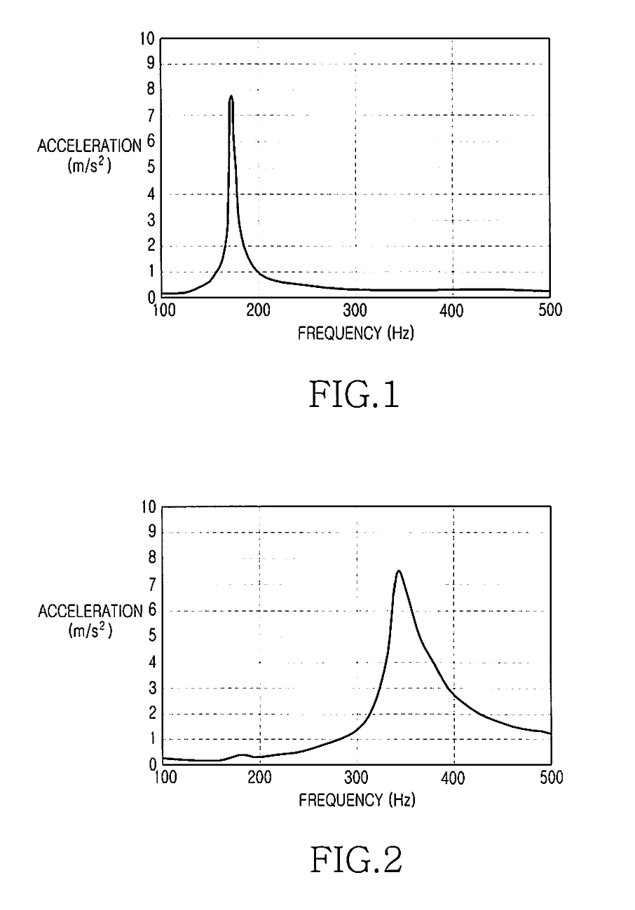

FIG. 1 indicates frequency characteristics of a receipt-specific vibration motor used in a haptic function control method of a portable terminal according to an embodiment of the present invention.

Referring to FIG. 1, the vibration power of the receipt-specific vibration motor drastically increases in a range of approximately 160 through 190 Hz, and the receipt-specific vibration motor provides a user with functions, such as an incoming call notification, by using the vibration of this frequency range. As described above, such a receipt-specific vibration motor is mainly used in informing functions, such as informing of an incoming a voice telephone call or a message reception, and is limited by its relatively long response time for use in haptic functions.

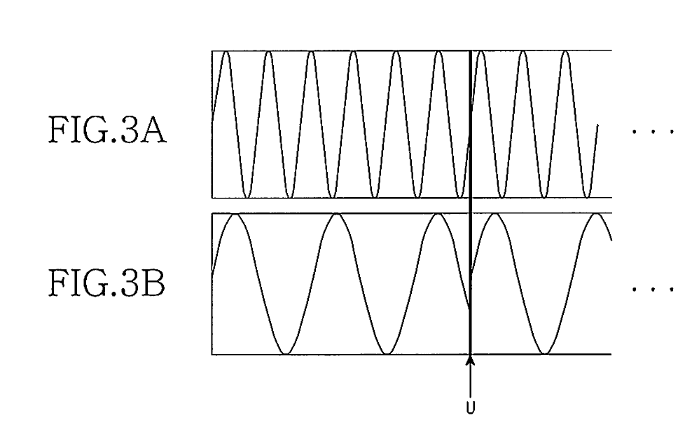

FIG. 2 indicates frequency characteristics of a haptic-specific vibration motor used in a haptic function control method of a portable terminal according to an embodiment of the present invention.

Referring to FIG. 2, the vibration power of the haptic-specific vibration motor drastically increases in a range of approximately 320 through 450 Hz, and some degree of vibration power that can be provided in a real haptic function also occurs in this vibration frequency band. In the vibration frequency band of the haptic-specific vibration motor, the haptic-specific vibration motor provides a vibration sensation of shortly cutting off and light touch reception as compared to the receipt-specific vibration motor. Such a haptic-specific vibration motor may be embodied as a linear motor, a piezoelectric motor etc., wherein the motor provides vibration tactility according to separate manipulations, even for a user's fast key input action because of it's the motor's short response time.

In contrast to the receipt-specific vibration motor, the haptic-specific vibration motor provides enough vibration power in a wider vibration frequency range. That is, the vibration power of the receipt-specific vibration motor drastically lowers when the receipt-specific vibration motor deviates around 10 Hz from a resonance frequency corresponding to approximately 170 Hz, whereas the haptic-specific vibration motor provides sensible vibration power in a vibration frequency band of 320 through 450 Hz, while it has a resonance frequency of around 340 Hz.

When two different vibration motors are actuated simultaneously, there can be side effects, such as an occurrence of a high frequency, due to discontinuity of a waveform at a junction of a unitary vibration pattern, as described above.

Accordingly, in accordance with an embodiment of the present invention, the receipt-specific and haptic-specific vibration motors synchronize to prevent an occurrence of such side effects, while simultaneously actuating. The synchronization is performed by sampling a drive sampling frequency signal of the receipt-specific and haptic-specific vibration motors as a common multiple of vibration frequencies of each vibration motor. That is, the drive sampling frequency signal is set as a common multiple of each vibration frequency of the receipt-specific and haptic-specific vibration motors.

As described above, the receipt-specific vibration motor has a resonance frequency of approximately 170 Hz, and can provide a sufficient degree of vibration power for an incoming call notification in a vibration frequency range of 160 through 190 Hz. Also, the haptic-specific vibration motor has a resonance frequency of approximately 340 Hz, but can still provide a sensible degree of vibration power to be used in a haptic function in a frequency range of 320 through 450 Hz. That is, the haptic-specific vibration motor can provide sufficient vibration tactility in the frequency range of 320 through 450 Hz and it does not necessarily operate in the resonance frequency.

As described above, a unitary drive sampling frequency signal that drives two vibration motors simultaneously, should be set as a common multiple of the vibration frequency of each vibration motor. If the common multiple of the vibration frequency of each vibration motor is an excessively high value, the haptic function may not be realized effectively. Thus, it is preferred that a common multiple to be set as the unitary vibration pattern is minimized by adjusting the vibration frequency of the haptic-specific vibration motor, because the haptic-specific vibration motor can provide sufficient vibration power in a relatively wider frequency range, even if it does not vibrate at a resonance frequency. as a result, it may be easy to adjust the actual vibration frequency of a haptic-specific vibration motor mounted in a product.

FIGS. 3A and 3B illustrate drive sampling frequency signals used in the receipt-specific and haptic-specific vibrator motors having frequency characteristics as illustrated in FIG. 1 and FIG. 2, respectively.

Referring to FIG. 3, when the drive sampling frequency does not correspond to a common multiple of each vibration frequency of the receipt-specific vibration motor and the haptic-specific vibration motor, the continuity of a waveform may not be maintained at the point indicated as ‘U’, which is at the junction of the continued unitary vibration pattern, and may cause a high frequency component.

Accordingly, minimizing a common multiple of the vibration frequency of the receipt-specific and haptic-specific vibration motors set as a unitary vibration pattern is desirable in the realization of a haptic function that simultaneously drives the two vibration motors. In this regard, it is preferred that when the receipt-specific vibration motor vibrates at a resonance frequency, double that frequency is included in the vibration frequency band of the haptic-specific vibration motor, that is in a frequency range of 320 through 450 Hz. As described above, the haptic-specific vibration motor does not necessarily need to vibrate at the resonance frequency when applied and operated in a real product.

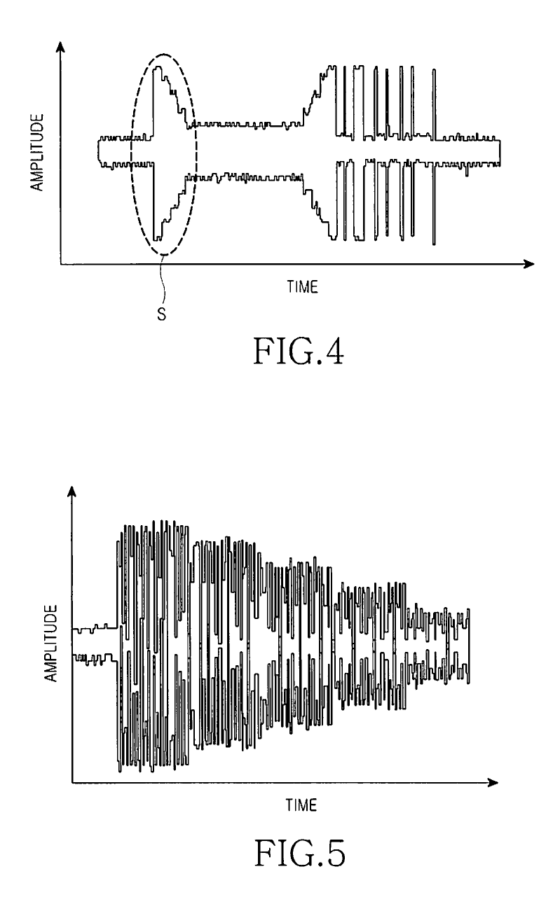

FIG. 4 illustrates an operation of a receipt-specific vibration motor having frequency characteristics as illustrated in FIG. 1, according to an embodiment of the present invention More specifically, FIG. 4 illustrates amplitude variation of the receipt-specific vibration motor, after a drive sampling frequency signal is applied.

FIG. 5 illustrates an enlargement of portion S, as illustrated in FIG. 4.

Referring to FIG. 5, a vibration pattern of locally regular amplitudes come into view when the drive sampling frequency signal is applied in the receipt-specific vibration motor. Even though a construction using this local vibration pattern is not specifically stated in a specific embodiment of the present invention, it may be possible to provide a haptic function by reproducing such a unitary vibration pattern irregularly or periodically.

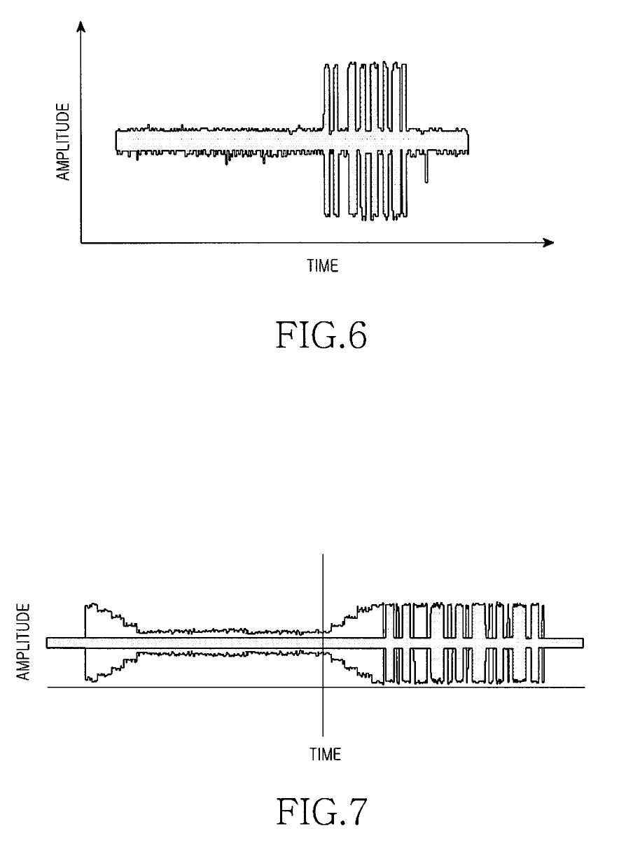

FIG. 6 illustrates an operation of a haptic-specific vibration motor having frequency characteristics as illustrated in FIG. 2, according to an embodiment of the present invention. FIG. 6 illustrates amplitude variation of the haptic-specific vibration motor, after a drive sampling frequency signal is applied.

FIG. 7 illustrates vibration characteristics according to a haptic-specific function control method of a portable terminal according to an embodiment of the present invention.

Referring to FIG. 7, when the receipt-specific vibration motor and the haptic-specific vibration motor are simultaneously actuated, for example, in response to a user's touch screen manipulation, vibration tactility of smooth and heavy feelings and vibration tactility of shortly cutting off and light feelings can be presented continuously or simultaneously while the user contacts a touch screen. Thus, when the drive sampling frequency signal is diversely set, vibration tactility of different feelings can be presented according to a user's touch screen manipulation form, i.e., an operation pattern such as dragging or continuously pressing.

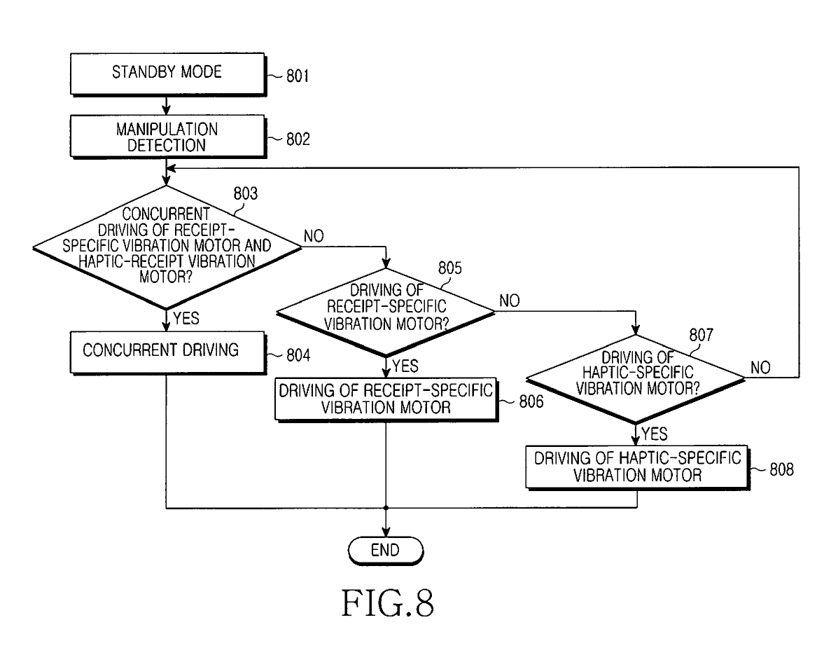

FIG. 8 is a flow chart illustrating a haptic operation of a portable terminal implementing a haptic-specific function control method according to an embodiment to the present invention. More specifically, FIG. 8 is a flow chart illustrating the driving at least one of the receipt-specific vibration motor and the haptic-specific vibration motor by applying a set drive sampling frequency signal. The control of the operation of the receipt-specific vibration motor and the haptic-specific vibration motor may be performed by a separate control unit.

Referring to FIG. 8, in step 801, when a power supply is on, a portable terminal, specifically, a touch screen and the receipt-specific and haptic specific vibration motors, remains in a standby state.

When a user manipulates the touch screen in step 802, the touch screen detects it and generates a corresponding drive sampling frequency signal. The drive sampling frequency signal is already set in the manufacture stage of the terminal. For example, a drive sampling frequency signal may be 320-450 Hz. However, when the period of a unitary vibration pattern is set as the least common multiple of the receipt-specific vibration motor and the haptic-specific vibration motor, the frequency of the drive sampling frequency signal is not limited to a special band.

In step 803, the terminal determines if the drive sampling frequency signal is for concurrently driving the receipt-specific and haptic specific vibration motors. If the signal is determined as a concurrent drive signal, the receipt-specific and haptic specific vibration motors are driven concurrently in step 804.

If the drive sampling frequency signal is not a concurrent drive signal in step 803, the terminal determines if the drive sampling frequency signal is for the receipt-specific vibration motor in step 805, and drives the receipt-specific vibration motor in step 806, if the drive sampling frequency signal is for the receipt-specific vibration motor. If the drive sampling frequency signal is not for the receipt-specific vibration motor in step 805, the terminal determines if the drive sampling frequency signal is for the haptic-specific vibration motor in step 807, and drives the haptic-specific vibration motor in step 808, if the drive sampling frequency signal is for the haptic-specific vibration motor.

If the drive sampling frequency signal does not correspond to the drive signal of the haptic-specific vibration motor in step 807, the process returns to step 803.

Although the present invention has been described with reference to certain embodiments thereof, it will be understood by those skilled in the art that various changes may be made therein without departing from the spirit and scope of the present invention as defined by the appended claims.

For example, a receipt-specific vibration motor with 170 Hz resonance frequency has been described above, although the vibration frequency of a receipt-specific vibration motor mounted on an actual portable terminal may vary.

What is claimed is:

1. A haptic function control method for a portable terminal including a receipt-specific vibration motor that vibrates in a first frequency band and a haptic-specific vibration motor that vibrates in a second frequency band, comprising:
driving at least one of the receipt-specific vibration motor and the haptic-specific vibration motor based on a drive sampling frequency signal,
wherein the drive sampling frequency signal that vibrates the receipt-specific vibration motor and the haptic-specific vibration motor is determined from the first frequency band and the second frequency band.

2. The method of claim 1, wherein the second frequency band is different from the first frequency band.

3. The method of claim 1, wherein when the receipt vibration motor and the haptic vibration motor vibrate simultaneously, the drive sampling frequency is a unitary vibration pattern set as a common multiple of the first frequency band and the second frequency band.

4. The method of claim 1, wherein the first frequency band is approximately 160 Hz through 190 Hz and the second frequency band is approximately 320 Hz through 450 Hz.

5. The method of claim 4, wherein the vibration frequency of the receipt-specific vibration motor is approximately 170 Hz.

6. The method of claim 1, wherein the haptic-specific vibration motor includes one of a linear motor or a piezoelectric motor.

7. A portable terminal for providing a haptic function comprising:
a receipt-specific vibration motor that vibrates in a first frequency band;
a haptic-specific vibration motor that vibrates in a second frequency band; and
a controller for driving at least one of the receipt-specific vibration motor and the haptic-specific vibration motor based on a drive sampling frequency signal,
wherein the drive sampling frequency signal is determined from the first frequency band and the second frequency band.

8. The portable terminal of claim 7, wherein the second frequency band is different from the first frequency band.

9. The portable terminal of claim 7, wherein when the receipt vibration motor and the haptic vibration motor vibrate simultaneously, the drive sampling frequency comprises a unitary vibration pattern set as a common multiple of the first frequency band and the second frequency band.

10. The portable terminal of claim 7, wherein the first frequency band is a range comprising approximately 160 Hz through 190 Hz and the second frequency band is a range comprising approximately 320 Hz through 450 Hz.

11. The portable terminal of claim 10, wherein the vibration frequency of the receipt-specific vibration motor is approximately 170 Hz.

12. The portable terminal of claim 7, wherein the haptic-specific vibration motor comprises one of:
a linear motor; and
a piezoelectric motor.
